(19) United States
(12) Patent Application Publication
(10) Pub. No.: US 2010/0045247 A1
(43) Pub. Date: Feb. 25, 2010

(54) PARALLEL ARRANGED LINEAR AMPLIFIER AND DC-DC CONVERTER

(75) Inventors: Pieter G. Blanken, Nuenen (NL); Paul Anthony Moore, Seaford (GB); Derk Reefman, Best (NL); Brian Minnis, Crawley (GB)

Correspondence Address: Docket Clerk, P.O. Box 802432, Dallas, TX, 75380, US

(73) Assignee: NXP B.V., Eindhoven (NL)

(21) Appl. No.: 11/911,702

(22) PCT Filed: Apr. 12, 2006
(86) PCT No.: PCT/IB06/51136

§ 371 Date: Oct. 26, 2009

(30) Foreign Application Priority Data
Apr. 20, 2005 (EP) 05300298.6
Aug. 29, 2005 (EP) 05300700.1
Apr. 12, 2006 (IB) PCT/IB2006/051136

(51) Int. Cl. G05F 1/10

(52) U.S. Cl. 323/273

(57) ABSTRACT

A power supply system comprises a parallel arrangement of a linear amplifier (LA) and a DC-DC converter (CO). The linear amplifier (LA) has an amplifier output to supply a first current (II) to the load (LO). The DC-DC converter (CO) comprises: a converter output for supplying a second current (12) to the load (LO), a first inductor (L1), and a switch (SC) coupled to the first inductor (L1) for generating a current in the first inductor (L1), and a low-pass filter (FI) arranged between the first inductor (L1) and the load (LO). The low pass filter (FI) comprises a first capacitor (C1; CA) which has a first terminal coupled to the switch (SC) an a second terminal coupled to a reference voltage level (GND), and a second inductor (L2; LC) which has a first terminal coupled to the first inductor (L1) and a second terminal coupled to the load (LO). The low-pass filter further comprises, either: (i) a series arrangement of a second capacitor (C2) and a damping resistor (R2), which series arrangement is arranged in parallel with the first capacitor (C1), or (ii) a parallel arrangement of a third capacitor (CB) and a damping resistor (RB) arranged in series with the first capacitor (CA), or (iii) a series arrangement of a third inductor (L3) and a damping resistor (R3), which series arrangement is arranged in parallel with the second inductor (L2), or (iv) a parallel arrangement of a fourth inductor (LD) and a damping resistor (RD), which parallel arrangement is arranged in series with the second inductor (LC).

### FIELD OF THE INVENTION

The invention relates to a power supply system with a parallel arrangement of a linear amplifier and a DC-DC converter, and an apparatus comprising such a power supply system.

### BACKGROUND OF THE INVENTION

U.S. Pat. No. 5,905,407 discloses a high efficiency power amplifier using combined linear and switching techniques with a feedback system. A linear amplifier supplies an output current to a load via a sense resistor. A switching amplifier which comprises a controllable switch and two series arranged LC-sections is used as a DC-DC converter and supplies a further output current to the load. The resistor is arranged between the output of the linear amplifier and the output node of the power supply system at which the output voltage is present across the load. The output current of the linear amplifier flows through this resistor. The voltage across the resistor is used to control the DC-DC converter to obtain a minimal DC-component of the output current of the linear amplifier. Preferably, this minimal DC component is zero.

This parallel arrangement of the linear amplifier and the DC-DC converter is applied in a radio transmitter. The radio transmitter comprises a power supply reference generator which supplies a reference signal to the linear amplifier to generate the system output voltage which tracks the reference signal. The radio transmitter further comprises a radio frequency (further referred to as RF) power amplifier for amplifying an RF signal. The RF amplifier is coupled to the output node to receive the system output voltage as a supply voltage. The reference signal is modulated to follow an amplitude modulation of the input signal of the RF amplifier. Thus, the supply voltage of the RF amplifier is controlled to meet the needs of the RF power amplifier to improve the efficiency of the RF amplifier.

The relatively slow DC-DC converter supplies the DC and low frequent currents to the load at relatively high power efficiency, and the relatively power inefficient linear amplifier supplies the high frequent currents to the load only.

The switching amplifier comprises a two-stage LC-filter. The two inductors of the LC-filter are arranged in series between the load and a switch of the switching amplifier which switch is connected to the DC input voltage. One of the capacitors of the LC-filter is connected between the junction of the two inductors and ground, the other capacitor of the LC-filter is connected in parallel with the load. The voltage at the junction of the two inductors is used by the feedback network to influence the control of the switches of the switching amplifier.

### SUMMARY OF THE INVENTION

It is an object of the invention to provide a parallel arranged linear amplifier and DC-DC converter with a less complex control of the DC-DC converter.

A first aspect of the invention provides a power supply system with a parallel arrangement of a linear amplifier and a DC-DC converter as claimed in claim 1. A second aspect of the invention provides an apparatus comprising the power supply system as claimed in claim 9. Advantageous embodiments are defined in the dependent claims.

The power supply system comprises a parallel arrangement of a linear amplifier and a DC-DC converter. The linear amplifier supplies a first current to the load which contains the high frequency components of the current drawn by the load. The DC-DC converter (further also referred to as converter) has a converter output to supply the second current to the load which contains the DC and low frequency components of the current drawn by the load. The converter further comprises a first inductor, and a controlled switch coupled to the first inductor to generate a varying current in the first inductor. The power supply system further comprises a low-pass filter arranged between the first inductor and the load. The low pass filter comprises: a first capacitor which has a first terminal coupled to the switch and a second terminal coupled to a reference voltage level, and a second inductor which has a first terminal coupled to the first inductor and a second terminal coupled to the load. The low pass filter further comprises one of the following sub-circuits:

(i) a series arrangement of a second capacitor and a damping resistor, which series arrangement is arranged in parallel with the first capacitor, or

(ii) a parallel arrangement of a third capacitor and a damping resistor, which parallel arrangement is arranged in series with the first capacitor, or

(iii) a series arrangement of a third inductor and a damping resistor, which series arrangement is arranged in parallel with the second inductor, or

(iv) a parallel arrangement of a fourth inductor and a damping resistor, which parallel arrangement is arranged in series with the second inductor.

The common issue is that the damping resistor is arranged in series with a capacitor or in parallel with an inductor. This in contrast to the prior art converter applications, wherein only additional LC filters are used without damping. However, these relatively lossless additional LC filters have a high quality factor and thus cause undesirable resonances. The prior art U.S. Pat. No. 5,905,407 suppresses these resonances by sensing the voltage at the input of the additional LC filter, and by adapting the feedback. This complicates the feedback system and may lead to instabilities or impaired performance of the feedback loop. It is commonly known, in small signal filtering applications, to damp resonances in LC filters with a damping resistor which is present in the main current loop. However, in these small signal filters a dissipation in the damping resistors is not an issue. In contrast, in low-pass filters which filter the output current of a DC-DC converter the power efficiency of the converter is a very relevant issue. Implementing damped small signal filter topologies in a filter for a DC-DC converter is not obvious because these have the commonly accepted drawback that the power efficiency of the converter is compromised by the high dissipation in the damping resistor.

The invention provides a low-pass filter in a power supply system which comprises a parallel arrangement of a linear amplifier and a DC-DC converter, which filter has a special construction to avoid additional DC power dissipation in the damping resistor, while providing good HF suppression.

The invention is based on the insight that the damping resistor should not be present in main current loop of the converter. The damping resistor may be arranged in series with a capacitor to a reference voltage which usually is ground. Or, the damping resistor is arranged in parallel with an inductor. This allows damping of the extra LC section without high dissipation in the damping resistor due to DC currents through the damping resistor.

Thus, the invention is based on two notions. One is the insight that the DC power dissipation in the damping resistor can be avoided, either by putting the damping resistor in series with a capacitor, thus blocking DC current, or by putting the damping resistor in parallel to an inductor, thus providing a DC current bypass because the resistance of the inductor is lower than that of the resistor. The other insight is that, in order to improve the HF (High Frequency) suppression of the filter, the HF behaviour should not be governed by the damping resistor, but must be governed by second-order LC behaviour.

The series arrangement of the capacitor and the damping resistor which conducts negligible DC current can be obtained by two equivalent circuits. In the first circuit, a capacitor is arranged in series with the damping resistor, and this series arrangement is arranged in parallel with the first capacitor which is arranged in the main current path between the first inductor and the reference voltage level. In a second circuit, a capacitor is arranged in parallel with the damping resistor, and the parallel arrangement is arranged in series with the first capacitor.

The DC current through the resistor in parallel with the extra inductor is relatively small because the resistance of the resistor is relatively large with respect to the resistance of the inductor with which the series arrangement is arranged in parallel. This parallel arrangement can be obtained by two equivalent circuits. In the first circuit, the inductor is arranged in series with the damping resistor, and the series arrangement is arranged in parallel with the second inductor which is arranged in the main current path between the first inductor and the load. In a second circuit, the inductor is arranged in parallel with the damping resistor, and the parallel arrangement is arranged in series with the second inductor. A same reasoning holds for low frequency currents. On the other hand the HF suppression of the filter is optimal because it is not degraded to a first order filter.

In an embodiment as claimed in claim 2, the second current provides the DC and low frequency portion of the load current, and the first current provides the high frequency portion of the load current. A crossover frequency is defined as the frequency at which the magnitude of the high frequency contribution is equal to the magnitude of the DC and low frequency contribution. The bandwidth of the low-pass filter is selected above the crossover frequency such that its current transfer magnitude is sufficiently large at the crossover frequency and the filter does not jeopardize the control loop stability.

In an embodiment as claimed in claim 3, the bandwidth of the low-pass filter is selected below a switching frequency of the DC-DC converter to obtain a current transfer suppression of the filter at the switching frequency.

In an embodiment as claimed in claim 4, the low pass filter comprises the second inductor and the series arrangement of the second capacitor and the damping resistor. The second capacitor has an impedance which is at least two times smaller than the impedance of the first capacitor. To effectively influence the filter performance, the impedance of the second capacitor should be at least two times, but preferably at least ten times, smaller than the impedance of the first capacitor.

In an embodiment as claimed in claim 5, the first capacitor, the second capacitor and the second inductor form a resonance circuit which has a first resonance frequency determined by values of the first capacitor, the second capacitor and the second inductor, and a second resonance frequency determined by the first capacitor and the second inductor. The first resonance frequency is lower than the second resonance frequency. The values of the first capacitor, the second capacitor and the second inductor are selected to obtain a second resonance frequency which is lower than a switching frequency of the DC-DC converter and which is higher than a crossover frequency. The crossover frequency is defined as the frequency at which the magnitude of the first current, which contains the high frequency portion of a total current through the load, is equal to the magnitude of the second current, which contains a DC and low frequency portion of the total current through the load.

In an embodiment as claimed in claim 6, the low pass filter comprises the second inductor and the series arrangement of the third inductor and the damping resistor. To effectively influence the filter performance, the third inductor has an impedance which is at least two times, but preferably at least ten times, smaller than the impedance of the second inductor.

In an embodiment as claimed in claim 7, the first capacitor, the second inductor, and the third inductor form a resonance circuit which has a first resonance frequency determined by values of the first capacitor and the second inductor, and a second resonance frequency determined by the first capacitor, the second inductor, and the third inductor. The first resonance frequency is lower than the second resonance frequency. The values of the first capacitor, the second inductor, and the third inductor are selected to obtain a second resonance frequency which is lower than a switching frequency of the DC-DC converter and higher than the crossover frequency. Again, the crossover frequency is defined as the frequency at which the magnitude of the first current containing the high frequency portion of the total current through the load, is equal to the magnitude of the second current containing the DC and low frequency portion of the total current through the load.

In an embodiment as claimed in claim 8, the linear amplifier comprises a first amplifier stage, a second amplifier stage, and a differential input stage. The differential input stage has a non-inverting input to receive a reference signal, an inverting input to receive a voltage proportional to a system output voltage across the load, and an output coupled to both an input of the first amplifier stage and an input of the second amplifier stage.

The first amplifier stage has an output directly connected to the load to supply the first current to the load. By directly connecting the output of the first amplifier stage to the load, the sense resistor in series with the output of the first amplifier stage, which usually is present to obtain a control voltage for the DC-DC converter, is not required. The first amplifier stage and the second amplifier stage have matched components to obtain a third current which is proportional to the first current. The DC-DC converter comprises a controller which has a control input to receive a voltage generated by the third current to control the second current, which is supplied by the DC-DC converter to the load, such that the DC-component of the first current is minimized.

These and other aspects of the invention are apparent from and will be elucidated with reference to the embodiments described hereinafter.

### BRIEF DESCRIPTION OF THE DRAWINGS

In the drawings:

FIG. 1 shows a block diagram of an apparatus comprising the power supply system in accordance with the invention,

FIG. 2 shows a block diagram of a power supply system and a circuit diagram of an embodiment of the low-pass filter,

FIG. 3 shows a block diagram of a power supply system and a circuit diagram of another embodiment of the low-pass filter,

FIG. 4 shows a circuit diagram of yet another embodiment of the low-pass filter, and

FIG. 5 shows a circuit diagram of yet another embodiment of the low-pass filter.

It should be noted that items which have the same reference numbers in different Figures, have the same structural features and the same functions, or are the same signals. Where the function and/or structure of such an item have been explained, there is no necessity for repeated explanation thereof in the detailed description.

### DETAILED DESCRIPTION

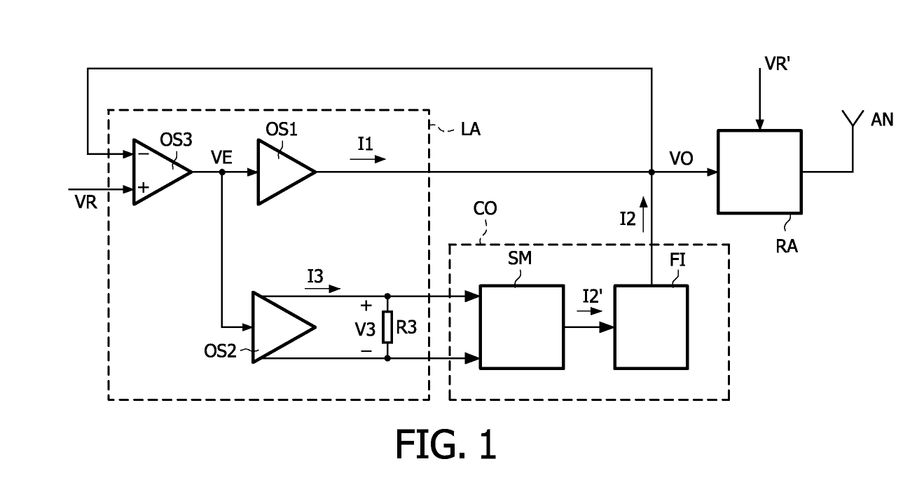

FIG. 1 shows a block diagram of an apparatus which comprises the power supply system in accordance with the invention. By way of example only, the apparatus shown is a telecom system. The power supply system is advantageous in any other apparatus which requires an efficient and fast power supply which is able to change the output voltage at a fast speed, or which is able to respond quickly to a change in the load of a circuit of the apparatus.

A power efficient RF (high frequency) power amplifier RA for use in, for example, 2.5G, 3G, or 4G telecom systems requires a fast and power efficient supply modulator. This supply modulator or power supply system supplies a rapidly varying supply voltage VO to the RF power amplifier RA. The supply voltage VO fits the output power to be supplied by the RF power amplifier RA. A fast and accurate control of the supply voltage VO, and thus of the current supplied by the power supply system, is especially important in handheld battery operated communication devices, such as, for example, mobile phones, to maximize the time a single battery charge can supply power to the system. The level of the supply voltage VO is only high during periods in time wherein a high output power is required. Thus, as soon as a lower output power is possible, the level of the supply voltage VO should be rapidly decreased to optimally fit the lower output power, and the other way around.

The power supply system comprises a linear amplifier LA and a DC-DC converter CO. The linear amplifier LA comprises the differential input stage OS3 and the amplifier stages OS1 and OS2. The differential input stage OS3 has an inverting input to receive a voltage proportional to the output voltage VO, a non-inverting input to receive the reference voltage VR, and an output to supply the error signal VE. The amplifier stage OS1 has an input to receive the error signal VE and an output to supply the output current I1 of the linear amplifier LA directly to the load which now comprises the RF power amplifier RA. The amplifier stage OS2 has an input to receive the error voltage VE, a differential output pair to obtain a current I3 through a resistor R3 arranged between the differential output pair. The current I3 causes a voltage V3 across the resistor R3. The controller (not shown) of the DC-DC converter CO uses the voltage V3 to control the switches of the DC-DC converter to obtain the output current I2 of the DC-DC converter CO. The DC-DC converter comprises a switching part SM and a low-pass filter FI. The switching part SM comprises the controller, at switch which is controlled by the controller, and an inductor which is coupled to the switch to obtain a varying current in the inductor. The exact topology depends on the type of DC-DC controller used.

The current I2′ which is supplied by the switching part SM is filtered by the low pass filter FI to obtain the filtered current I2 which is supplied to the load. The filter FI suppresses the ripple of the DC-DC converter CO. The present invention is directed to the construction of the low-pass filter FI.

Another reference voltage VR′ is fed to the RF power amplifier RA. Usually the reference voltage VR only comprises amplitude information while the reference voltage VR′ comprises phase information and may comprise amplitude information. Thus, if output power of the RF amplifier has to rapidly increase, the control signal VR commands the power supply system to increase the currents I1 and I2. The relatively slow DC-DC converter CO cannot immediately follow a fast step of the reference signal VR. The difference between the required current to the load and the current I2 supplied by the DC-DC converter CO will be supplied as the current I1 by the linear amplifier. Once a stable situation is reached, the DC and low frequency part of the current required by the RF power amplifier RA is delivered by the DC-DC converter CO, and the current I1 adds the high frequency part of the current required by the RF power amplifier RA and subtracts (part of) the inherent ripple of the DC-DC converter CO. Instead of the resistor R3 which converts the current I3 into a control voltage for the DC-DC converter CO, a capacitor may be used which replaces the resistor R3, or which is arranged as a Miller capacitor between an input and an output of an inverting amplifier OS2.

Instead of the shown topology to control the DC-DC converter CO which topology comprises the linear amplifier LA which has the amplifier stage OS1 of which the output is directly connected to the load, and an amplifier stage OS2 which generates a current I3 proportional to the current I1, alternatively, other topologies may be used to control the DC-DC converter CO. For example, although the direct connection of the output of the amplifier OS1 to the load has the advantage that it is not required adding an element which senses the current I1, such an element may be present in the main current loop. This element may be a resistor or another current sensor. Now, the voltage across the resistor is used to control the DC-DC converter CO and the amplifier OS2 is not required anymore. However such a current sensor which is present in the main current loop of the linear amplifier LA influences the loop stability and causes a relatively high dissipation.

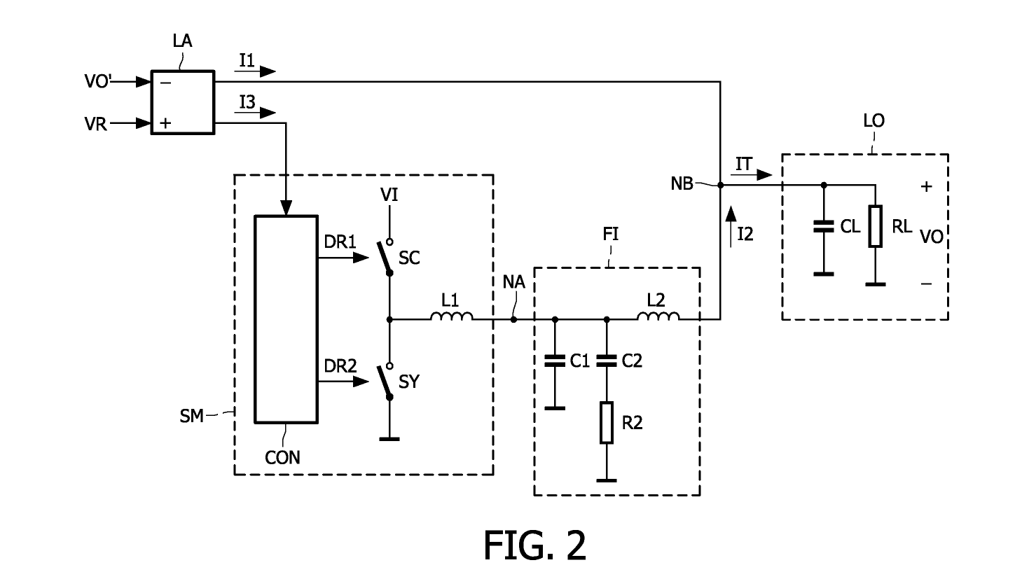

FIG. 2 shows a block diagram of a power supply system and a circuit diagram of an embodiment of the low-pass filter.

The switching part SM of the DC-DC converter CO comprises a controller CON, a switch SC, a switch SY, and an inductance L1. The switches SC and SY have main current paths which are arranged in series to receive an input supply voltage VI. One end of the inductance L1 is connected to the junction of the main current paths of the switches SC and SY. The controller controls the switches SC and SY with control signals DR1 and DR2, respectively. It has to be noted that the switching part SM shown is an example only. The inductance L1 may be a coil or a transformer. The present low-pass filter FI can also be advantageously used together with other DC-DC converters.

The linear amplifier LA comprises an inverting input to receive a voltage VO′ proportional to the output voltage VO, a non-inverting input to receive the reference voltage VR, an output to supply the output current I1 directly to the load LO, and an output to supply the current I3 to the controller CON of the switching part SM of the DC-DC converter CO. The current I3 may be converted to a voltage before being fed to the controller CON. The linear amplifier LA may be constructed identical to what is shown in FIG. 1. The controller CON receives the current I3 to control the switches SC and SY to obtain a current I2 such that the average value of the current I1 is substantially zero.

The low-pass filter FI is arranged between the free end of the inductance L1 at a node NA and the load LO at a node NB. The load LO comprises a parallel arrangement of a smoothing capacitor CL and the load impedance RL which often is a resistance. The current through the load LO is referred to as IT. The low-pass filter FI comprises an inductor L2 which is arranged between the nodes NA and NB, a capacitor C1 arranged between the node NA and ground, and a series arrangement of the capacitor C2 and the resistor R2 arranged between the node NA and ground.

In the now following, the dimensioning of the low-pass filter FI is elucidated for a practical realization. This is an example only, other practical implementations are possible as well. A first important parameter is the switching frequency of the DC-DC converter CO, which is 10 MHz in this particular example. The DC-DC converter CO adds a ripple current to the system. The additional filter FI should suppress this ripple. Another important frequency is the crossover frequency at which the contribution to the load current IT of the output current I2 of the low-pass filter FI is substantially equal in magnitude to the contribution to the load current IT of the output current I1 of the linear amplifier LA. In the example discussed, the crossover frequency is 0.2 MHz.

The additional low-pass filter FI should be designed to obtain a current transfer magnitude which is sufficiently large at the crossover frequency. Now, the filter does not jeopardize the control loop stability. While at the switching frequency its current transfer suppression is sufficiently large to obtain sufficient ripple suppression.

The low-pass filter shown in FIG. 2 has two resonance frequencies:

$$FRES 1 = \frac{1}{2 \cdot π \cdot \sqrt{L 2 \cdot ( C 1 + C 2 )}}$$

$$FRES 2 = \frac{1}{2 \cdot π \cdot \sqrt{L 2 \cdot C 1}}$$

wherein FRES1<FRES2.

For small values of the damping resistance R2, the filter will resonate at frequencies close to the resonance frequency FRES1, whereas for large values of the resistance R2 it will resonate at frequencies close to the resonance frequency FRES2.

In a practical realization of the low-pass filter, the capacitor C2 must have a value which at least is two times the value of the capacitor C1, but which preferably is a factor 10 to 100 larger, such that the series arrangement of the capacitor C2 and the resistor R2 effectively influences the filter performance. The resonance frequency FRES2 must be selected lower than the switching frequency, and higher than the crossover frequency. For example, the resonance frequency FRES2 may be selected to be 1.4 MHz. The value of the inductor L2 is determined by parameters such as the required rate-of-change in time of the filter output current I2, a volume and size of the inductor L2, and a saturation current limit of the inductor L2. In the present example wherein the switching frequency is 10 MHz, preferably, the value of the inductor L2 is selected within the range from 0.1 μH to 5 μH. By way of example, the value of the inductor L2 is selected to be 1 μH. The value of the capacitor C1 is then 12 nF. The value of the capacitor C2 is selected a factor 22.5 larger than the value of the capacitor C1: C2=270 nF.

For the damping resistor R2 preferably values are chosen which are in a range around a characteristic impedance ZKAR2:

$$ZKAR 2 = \sqrt{\frac{L 2}{\sqrt{C 1 \cdot C 2}}}$$

Preferably, the range for the resistance value of R2 is defined by values between a lower limit which is 5 times smaller than characteristic impedance ZKAR2 and an upper limit which is 5 times larger than characteristic impedance ZKAR2. In the example discussed, the characteristic impedance ZKAR2=4.2Ω, and the resistance value of R2 may be selected from the range 1 to 20Ω, for example: R2=4.7Ω.

In another embodiment in accordance with the invention, an inductor is added to the series arrangement of the capacitor C2 and the damping resistor R2, such that the series arrangement of the inductor, the capacitor C2 and the resistor R2 is arranged in parallel with the capacitor C1. Again the impedance of the capacitor C2 is smaller than the impedance of the capacitor C1. The series circuit of the inductor, the capacitor C2 and the resistor R2 may be tuned to the switching frequency, or to another frequency substantially above the −3 dB bandwidth of this low-pass filter.

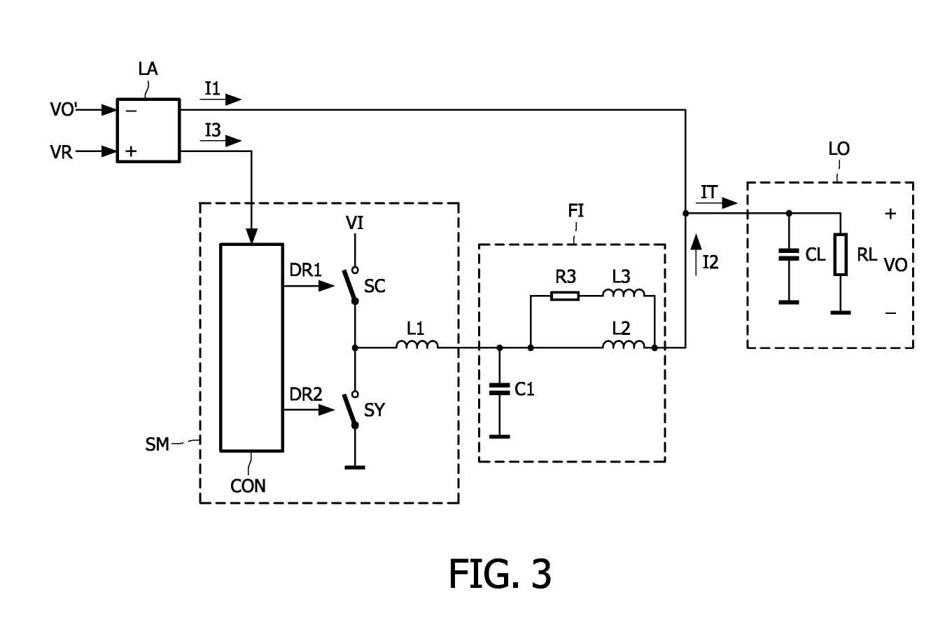

FIG. 3 shows a block diagram of a power supply system and a circuit diagram of another embodiment of the low-pass filter. This power supply system is based on the one shown in FIG. 2. The only difference is that the series arrangement of the capacitor C2 and the resistor R2 is replaced by a series arrangement of the inductor L3 and the resistor R3. The latter mentioned series arrangement is arranged in parallel with the inductor L2.

Again two resonance frequencies can be indicated:

$$FRES 1 = \frac{1}{2 \cdot π \cdot \sqrt{L 2 \cdot C 1}}$$

$$FRES 2 = \frac{1}{2 \cdot π \cdot \sqrt{\frac{L 2 \cdot L 3}{L 2 + L 3} \cdot C 1}}$$

wherein FRES1<FRES2.

For large values of the damping resistor R3 the filter resonates at frequencies close to the resonance frequency FRES1, whereas for small values of the damping resistor R3 it resonates at frequencies close to the resonance frequency FRES2.

In a practical realization of the low-pass filter, the inductor L3 must have a value which at least is two times smaller than the value of the inductor L2, but which preferably is a factor 10 to 100 smaller, such that the series arrangement of the inductor L3 and the resistor R3 effectively influences the filter performance. The resonance frequency FRES2 must be selected lower than the switching frequency of the DC-DC converter, and higher than the crossover frequency. The value of the inductor L2 is determined by parameters such as the required rate-of-change in time of the filter output current I2, a volume and size of the inductor L2, and a saturation current limit of the inductor L2. In the present example wherein the switching frequency is 10 MHz, the value of the inductor L2 is preferably selected out of the range from 0.1 μH to 5 μH.

For the damping resistor R3 preferably values are chosen which are in a range around a characteristic impedance ZKAR3:

$$ZKAR 3 = \sqrt{\frac{\sqrt{L 2 \cdot L 3}}{C 1}}$$

Preferably, the range for the resistance value of R3 is defined by values between a lower limit which is 5 times smaller than characteristic impedance ZKAR3 and an upper limit which is 5 times larger than characteristic impedance ZKAR3.

In a practical embodiment the following values are selected: the resonant frequency FRES2 is 1.4 MHz, the inductor L2=1 μH, the inductor L3=100 nH, the capacitor C1=150 nF, the characteristic impedance ZKAR3=1.5Ω, and the resistor R3 is selected within the range from 0.3 to 10Ω. For example, the resistor R3=1.5Ω.

It has to be noted that it is known that a LC filter can be damped by adding a damping resistor. However, as these filters are usually implemented in applications in which small currents are flowing, the dissipation in the damping resistor is not an issue. These known damping solutions are in the now following discussed with respect to the embodiments in accordance with the invention as shown in FIGS. 2 and 3.

In one prior art solution, the capacitor C2 in FIG. 2 is not present. Or analogously, in FIG. 3, the series arrangement of the resistor R3 and the inductor L3 is not present, and the damping resistor R3 is arranged in series with the inductor L2. This approach has the advantage that a good high-frequency suppression is obtained but has the drawback that a high DC power dissipation occurs in the resistor.

In another prior art damping technique the capacitor C1 shown in FIG. 2 or the inductor L3 in FIG. 3 is not present. Although these techniques do not suffer from the additional DC power dissipation, they have the drawback of reduced high-frequency suppression with respect to the fourth order two LC-section filter disclosed in U.S. Pat. No. 5,905,407. In the FIGS. 2 and 3, which are amended as discussed above, for high frequencies, the second-order section with capacitor C2 and inductor L2 behaves as a first-order section with resistor R2 and inductor L2, and as a first-order section with capacitor C2 and resistor R3, respectively. Thus, instead of a fourth order filter, only a third order filter is obtained.

The invention has the objective to avoid additional DC power dissipation in the damping resistor, while providing good HF suppression (namely fourth-order LC behaviour).

In another embodiment in accordance with the invention, a capacitor is added parallel to damping resistor R3, such that the parallel arrangement of resistor R3 and the capacitor is arranged in series with inductor L3. Again the impedance of the inductor L3 is smaller than the impedance of the inductor L2. The series circuit of the inductor L3 and the parallel arrangement of the capacitor and the resistor R3 may be tuned to the switching frequency, or to another frequency substantially above the −3 dB bandwidth of this low-pass filter.

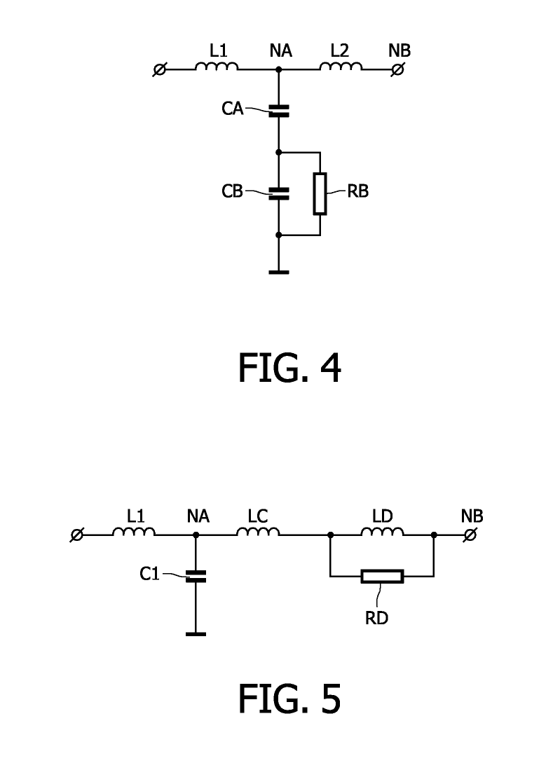

FIG. 4 shows a circuit diagram of yet another embodiment of the low-pass filter. FIG. 4 shows the part of FIG. 2 including the first inductor L1 and the low-pass filter FI which is arranged between the nodes NA and NB. The parallel arrangement of the capacitor C1 with series arrangement of the capacitor C2 and the damping resistor R2 of FIG. 2 is replaced by the equivalent circuit of the series arrangement of the capacitors CA and CB, and the damping resistor RB which is arranged in parallel with the capacitor CB. The series arrangement of the capacitors CA and CB is arranged between the node NA and the reference voltage level (GND). The capacitor CA replaces the capacitor C1 of FIG. 2.

The values of the capacitors CA, CB and the resistor RB can be easily determined from the values selected for the equivalent circuit shown in FIG. 2:

CA=C1+C2

CB=(C1+C2)*C1/C2

RB=R2*(C2*C2((C1+C2)*(C1+C2)))

FIG. 5 shows a circuit diagram of yet another embodiment of the low-pass filter. FIG. 5 shows the part of FIG. 3 including the first inductor L1 and the low-pass filter FI which is arranged between the nodes NA and NB. The series arrangement of the damping resistor R3 and the inductance L3 is replaced by a parallel arrangement of the inductance LD and the damping resistor RD. This parallel arrangement is arranged in series with the inductor LC which replaces the inductor L2 of FIG. 3.

The values of the inductors LC, LD and the resistor RD can be easily determined from the values selected for the equivalent circuit shown in FIG. 3:

LC=L2*L3/(L2+L3)

LD=L2*L2/(L2+L3)

RD=R3*(L2*L2/((L2+L3)*(L2+L3)))

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A power supply system comprising a parallel arrangement of a linear amplifier and a DC-DC converter, wherein: the linear amplifier has an amplifier output for supplying a first current to the load, and the DC-DC converter comprises a converter output for supplying a second current to the load, a first inductor, and a switch coupled to the first inductor for generating a varying current in the first inductor, and a low-pass filter arranged between the first inductor and the load, the low pass filter comprises: a first capacitor having a first terminal coupled to the switch and a second terminal coupled to a reference voltage level, a second inductor having a first terminal coupled to the first inductor and a second terminal coupled to the load, and either: a series arrangement of a second capacitor and a damping resistor, which series arrangement is arranged in parallel with the first capacitor, or a parallel arrangement of a third capacitor and a damping resistor, which parallel arrangement is arranged in series with the first capacitor, or a series arrangement of a third inductor and a damping resistor, which series arrangement is arranged in parallel with the second inductor, or a parallel arrangement of a fourth inductor and a damping resistor, which parallel arrangement is arranged in series with the second inductor.

2. A power supply system as claimed in claim 1, wherein, in use, the second current provides a DC and low frequency portion of a total current through the load, the first current provides a high frequency portion of the total current through the loading, a crossover frequency being defined as the frequency at which the high frequency portion is equal in magnitude to the DC and low frequency portion, and wherein a bandwidth of the low-pass filter is selected above the crossover frequency.

3. A power supply system as claimed in claim 1, wherein a bandwidth of the low-pass filter is selected below a switching frequency of the DC-DC converter to obtain a current transfer suppression of the low-pass filter at the switching frequency.

4. A power supply system as claimed in claim 1, wherein the low pass filter comprises the second inductor and the series arrangement of the second capacitor and the damping resistor, and wherein the second capacitor has an impedance which is at least two times smaller than the impedance of the first capacitor.

5. A power supply system as claimed in claim 4, wherein the first capacitor, the second capacitor and the second inductor form a resonance circuit having a first resonance frequency determined by values of the first capacitor, the second capacitor and the second inductor, and a second resonance frequency determined by the first capacitor and the second inductor, the first resonance frequency being lower than the second resonance frequency, and wherein values of the first capacitor, the second capacitor and the second inductor are selected to obtain the second resonance frequency lower than a switching frequency of the DC-DC converter and higher than a crossover frequency, wherein the crossover frequency is defined as the frequency at which, in use, the first current which provides a high frequency portion of a total current through the load is equal in magnitude to the second current which provides a DC and low frequency portion of the total current through the load.

6. A power supply system as claimed in claim 1, wherein the low pass filter comprises the second inductor, and the series arrangement of the third inductor and the damping resistor, and wherein the third inductor has an impedance which is at least two times smaller than the impedance of the second inductor.

7. A power supply system as claimed in claim 6, wherein the first capacitor, the second inductor, and the third inductor form a resonance circuit having a first resonance frequency determined by values of the first capacitor and the second inductor, and a second resonance frequency determined by the first capacitor, the second inductor, and the third inductor, the first resonance frequency being lower than the second resonance frequency, and wherein values of the first capacitor, the second inductor, and the third inductor are selected to obtain the second resonance frequency lower than a switching frequency of the DC-DC converter and higher than a crossover frequency, wherein the crossover frequency is defined as the frequency at which, in use, the first current which provides a high frequency portion of a total current through the load is equal in magnitude to the second current which provides a DC and low frequency portion of the total current through the load.

8. A power supply system as claimed in claim 1, wherein the linear amplifier comprises: a first amplifier stage having an output directly connected to the load for supplying the first current to the load, a second amplifier stage for generating a third current being proportional to the first current, the first amplifier stage and the second amplifier stage having matched components, and a differential input stage having a non-inverting input for receiving a reference signal, an inverting input for receiving a voltage proportional to a system output voltage across the load, and an output being coupled to both an input of the first amplifier stage and an input of the second amplifier stage, and wherein the DC-DC converter further comprises a controller having a control input for receiving a voltage generated by the third current to control the second current for minimizing a DC-component of the first current.

9. An apparatus comprising the power supply system as claimed in claim 1, wherein the load comprises a circuit of the apparatus.

10. An apparatus as claimed in claim 9, the apparatus comprising a telecom system wherein the load comprises an RF amplifier.
